(19) United States
(12) Patent Application Publication
(10) Pub. No.: US 2012/0219473 A1
(43) Pub. Date: Aug. 30, 2012

(54) SAMPLE RACK

(75) Inventors: Kimihiko Ishii, Hitachinaka (JP); Mitsuhiko Ueda, Hitachinaka (JP); Shoji Tomida, Hitachinaka (JP); Akira Kuroda, Mito (JP); Hiromi Yamashita, Ishioka (JP)

(73) Assignee: HITACHI HIGH-TECHNOLOGIES CORPORATION, Minato-ku, Tokyo (JP)

(21) Appl. No.: 13/503,874

(22) PCT Filed: Oct. 29, 2010
(86) PCT No.: PCT/JP2010/069315

§ 371 Date: Apr. 25, 2012

(30) Foreign Application Priority Data
Nov. 4, 2009 (JP) 2009-253199

(51) Int. Cl. B01L 9/00

(52) U.S. Cl. 422/561

(57) ABSTRACT

A sample rack 1 in which sample holding container 6 containing sample liquid is loaded and cooled via a cooling device 8 includes containing sections 40 adapted to receive the sample holding containers 6, and groove portions 11 disposed with inclination below the bottom surface of the containing section 40. The bottom surface of the containing section 40 communicates with the groove portion 11. The dew condensation water introduced into the groove portion 11 is discharged to the outside of the sample rack 1 via an opening portion 12 provided on the side surface of the sample rack 1. In this way, since the dew condensation water is forcibly discharged, workability encountered during removal of the sample rack and sample cooling capacity can be improved.

### TECHNICAL FIELD

The present invention relates to a sample rack supporting sample holding containers.

### BACKGROUND ART

Some liquid chromatographic apparatuses have an automatic sample introduction device (an automated sampler). In the apparatus, sample liquid contained in a sample holding container (sample bottle) arranged in a sample rack mounted to a rack holder is sucked with a needle and automatically injected into a mobile-phase passage of the apparatus. The sample rack of the liquid chromatographic apparatus is configured to be removable from the rack holder in some cases. With such a configuration, the sample rack is removed from the rack holder and attachment and detachment work for the sample holding container can be performed at another place. Thus, user's operability can be enhanced. If a plurality of the sample racks are prepared and installation work for the sample holding containers is previously done, sample liquid can be replaced quickly.

To obtain assay results with high reproducibility through liquid chromatography, it is required that the concentration of sample liquid to be analyzed be stable. In other words, it is important to keep the temperature of the sample liquid constant during the analysis. In general, when sample liquid to be analyzed through liquid chromatography is prepared, organic solvent (or liquid partially containing organic solvent) is frequently used as liquid dissolving a sample to be analyzed. However, as the boiling point of an organic solvent is lower, the saturated vapor pressure thereof at a certain temperature and a vapor rate therefor become higher. Therefore, the concentration of the sample liquid tends to vary. Because of this, the liquid chromatography generally performs analysis in a state where a sample liquid is cooled to approximately 4 to 15° C. and its temperature is kept constant. Therefore, a sample cooling device is sometimes used to cool the sample liquid in the sample holding container.

Sample cooling devices are such that while sample liquid is cooled, dew condensation occurs on a sample holding container or a sample rack depending on conditions: environmental conditions such as ambient temperature, ambient moisture and the like; a target temperature setting condition; or configuration conditions such as a sample rack, a rack holder and the like. Dew condensation may occur on the upper portion (e.g. a septum) of the sample holding container. In such a case, dew condensation water, along with a needle, enters the inside of the sample holding container to vary sample concentration, which causes an erroneous assay result in some cases.

With this point in mind, a sample rack (sample holders) has a sample cooling device installed below a sample rack main body whose bottom portion is made of metal. This sample cooling device is mainly intended to cool the bottom portion of the sample holding container, thereby suppressing the occurrence of dew condensation on the upper portion of the sample holding container. (See JP-UM-3-17542-A) Another sample rack is configured as follows. A drain discharge hole is provided on a bottom portion of a containing section for a sample holding container in a sample rack main body. The sample rack main body is made of synthetic resin with lower thermal conduction efficiency than metal. Dew condensation water held between the discharge hole and the bottom surface of the sample holding container is used to mainly cool the bottom portion of the sample holding container. In this way, it is contemplated to suppress the occurrence of dew condensation on the upper portion of the sample holding container. (See JP-UM-4-88843-A)

### PRIOR-ART DOCUMENTS

### Patent Documents

Patent document 1: JP-UM-3-17542-A
Patent document 2: JP-UM-4-88843-A

### SUMMARY OF THE INVENTION

### Problem to be Solved by the Invention

However, the two above documents described about a sample rack do not describe the specific configuration for discharging dew condensation water from the drain hole formed in the bottom portion of the containing section. Therefore, dew condensation water that has been formed may probably accumulate inside the sample rack or the rack holder. (Considering the point where dew condensation water held between the drain hole and the bottom surface of the containing section of the sample holding container is used to try the cooling promotion for sample liquid, it is speculated that dew condensation water is not forcibly discharged to the outside.) If the dew condensation water accumulates, when the sample rack is removed from the rack holder, the dew condensation water may probably be scattered on a user or the vicinity thereof. This may degrade workability encountered during removal of the sample rack. If the dew condensation water accumulates as described above, the sample liquid in the sample holding container will be cooled via the dew condensation water. However, cooling capacity ΔT (a difference between reachable temperature and ambient temperature) lowers compared with the case where the sample liquid is cooled via a material with high efficiency of thermal conduction such as metal or the like. Therefore, it is probable that target temperature is not reached.

It is an object of the present invention to provide a sample rack having improved workability encountered during removal and high sample cooling capacity.

### Means for Solving the Problem

(1) To achieve the above object, the present invention provides a sample rack in which a sample holding container containing sample liquid is loaded, the sample rack comprising: a containing section in which the sample holding container is contained; and a groove portion disposed with inclination below the containing section; wherein a bottom surface of the containing section communicates with the groove portion.

(2) In the above (1), preferably, the containing section is configured to be able to come into contact with a bottom surface and a side surface of the sample holding container when the sample holding container is contained in the containing section.

(3) In the above (1), preferably, the groove portion is disposed with inclination below the bottom surface of the containing section, communicates with an outside at an end where the inclination is steepest, and further communicates with a side surface of the containing section.

(4) In the above (1), preferably, the containing section has, as a part of the containing section, a containing-section lower portion adapted to receive a bottom surface and a side surface of the sample holding container, and as a part of the containing section, a containing-section upper portion located above the containing-section lower portion and adapted to receive the side surface of the sample holding container; and the containing-section lower portion is formed of a material with relatively higher efficiency of thermal conduction as compared with that of the containing-section upper portion.

(5) In the above (4), preferably, the height of the containing-section lower portion is equal to or lower than that of a barrel portion of the sample holding container when the sample container is contained in the containing section.

(6) In the above (1), a sample cooling device comprises: the sample rack according to the above (1); a rack holder removably supporting the sample rack; a cooling device adapted to cool the rack holder; and water storing means for storing water discharged from the groove portion.

(7) In the above (6), preferably, the rack holder is formed of a material with relatively higher efficiency of thermal conduction as compared with that of the containing-section upper portion.

(8) In the above (6), preferably, the rack holder has other groove portion disposed with inclination below the groove portion and adopted to receive water discharged from the groove portion, and the water storing means stores water that has been discharged from the groove portion and passed through the other groove portion.

### Effect of the Invention

According to the present invention, dew condensation water is forcibly discharged; therefore, workability encountered during removal of the sample rack and sample cooling capacity can be improved.

### BRIEF DESCRIPTION OF DRAWINGS

FIG. 1 is an overview illustration of an automatic sample introduction device of a liquid chromatographic apparatus, according to an embodiment of the present invention.

FIG. 2 is a configurational view of a sample holding container to be loaded in a sample rack according to an embodiment of the present invention.

FIG. 3 is a configurational view of the sample rack according to the embodiment of the present invention.

FIG. 4 is a plan view of a lower member of the sample rack according to the embodiment of the present invention.

FIG. 5 is a cross-sectional view of the lower member taken along plane V-V in FIG. 4.

FIG. 6 is a cross-sectional view of the lower member taken along plane VI-VI in FIG. 4.

FIG. 7 is a perspective view of the lower member of the sample rack according to the embodiment of the present invention.

FIG. 8 is a configurational view of a rack holder and the vicinity thereof according to the embodiment of the present invention.

FIG. 9 is an overview illustration showing the configuration of a cooling device of an automatic sample introduction device according to another embodiment of the present invention.

FIG. 10 is a plan view of a lower member of a sample rack according to another embodiment of the present invention.

FIG. 11 is a cross-sectional view of the lower member taken along plane XI-XI in FIG. 10.

FIG. 12 is a plan view of a first member of a rack holder according to another embodiment of the present invention.

FIG. 13 is a cross-sectional view of the first member take along plane XIII-XIII in FIG. 12.

### MODE FOR CARRYING OUT THE INVENTION

Embodiments of the present invention will hereinafter be described with reference to the drawings.

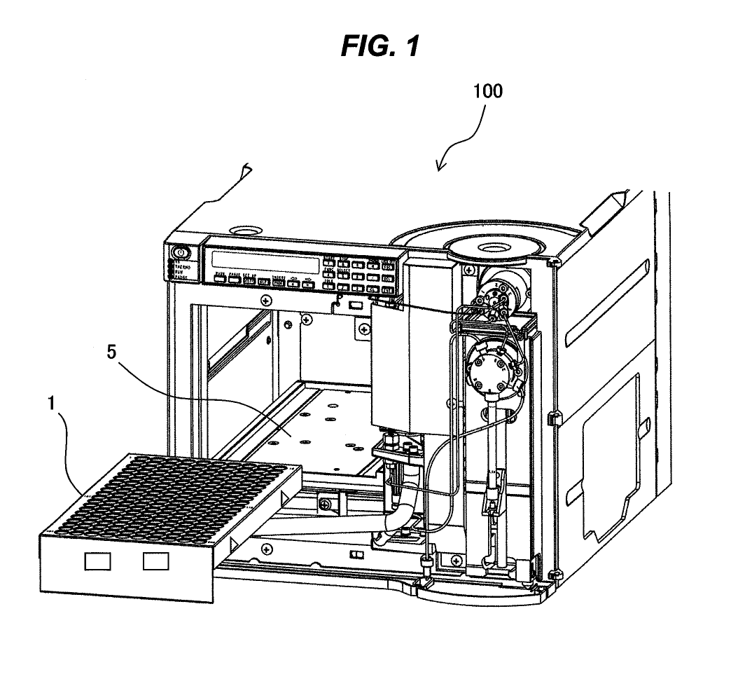

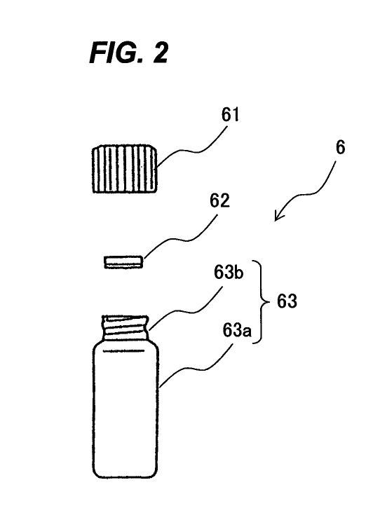

FIG. 1 is an overview illustration of an automatic sample introduction device 100 of a liquid chromatographic apparatus, according to an embodiment of the present invention. The sample introduction device 100 shown in the figure includes a sample rack 1 in which sample holding container 6 (see FIG. 2) containing sample liquid is loaded; and a rack holder 5 supporting the sample rack 1. In addition, the sample introduction device 100 has a function of cooling the sample in the sample holding container 6.

FIG. 2 is a configurational view of the container holding container 6 to be loaded in the sample rack 1. The sample holding container 6 shown in the figure is formed generally cylindrical and includes a cap 61, a septum 62 and a sample bottle 63. The sample bottle 63 is composed of a barrel portion 63a that is formed into approximately cylindrical shape and a neck portion 63b having a diameter smaller than that of the barrel portion 63a, the neck portion 63b having an opening portion. A sample liquid to be measured is served into the sample bottle 63. The opening portion of the sample bottle 63 is sealed by the cap 63 via the septum 62.

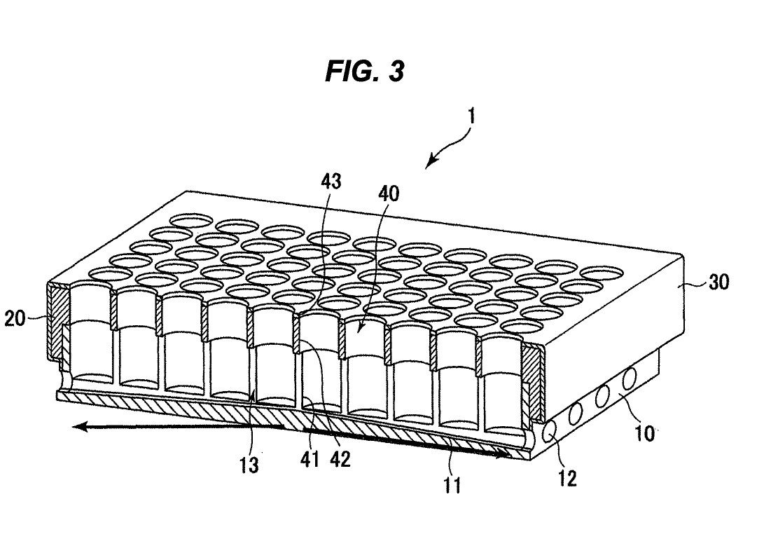

FIG. 3 is a configurational view of the sample rack 1 according to the embodiment of the present invention. Incidentally, the same portions as those in the previous figures are denoted with like reference numerals and their explanations are omitted (the same holds true for the following figures).

In the figure, the sample rack 1 includes a lower member 10 in contact with the rack holder 5 in the sample introduction device 100; an upper member 20 mounted on the upper portion of the lower member 10; and a cover member 30 mounted on the upper portion of the upper member 20. A plurality of containing sections 40 in which the sample holding containers 6 are contained are arranged in a lattice pattern in the sample rack 1 assembled from the lower member 10, the upper member 20 and the cover member 30. Although details are described later, the containing sections 40 are each formed of a containing-section lower portion 41 of the lower member 10, a containing-section upper portion 42 of the upper member 20, and a hole 43 of the cover member 30.

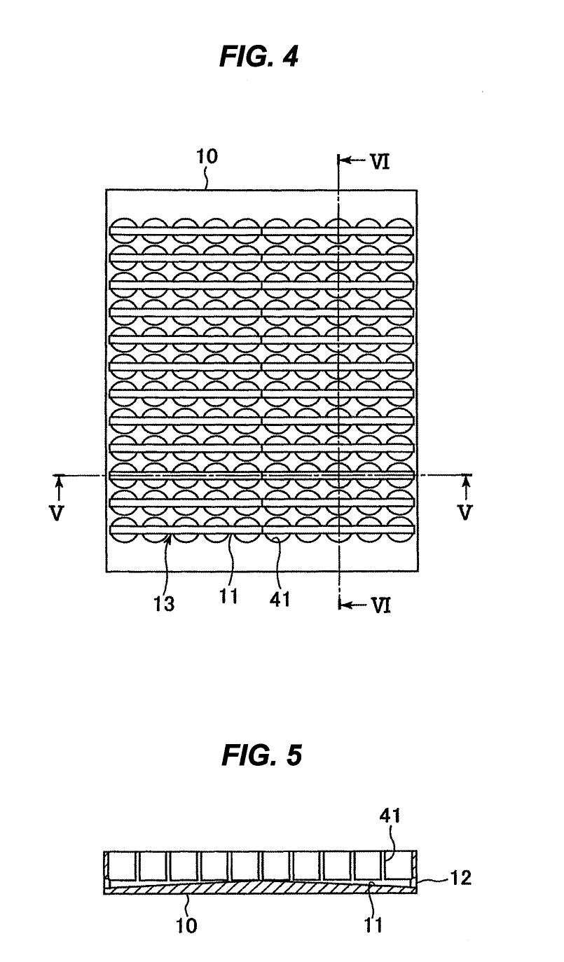

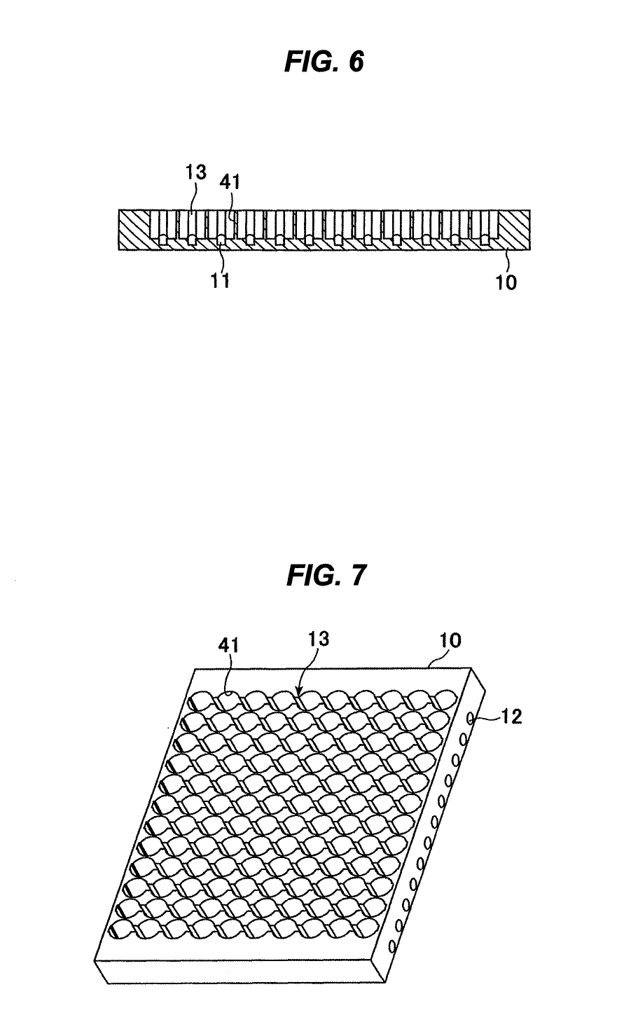

FIG. 4 is a plan view of the lower member 10 of the sample rack 1. FIG. 5 is a cross-sectional view of the lower member taken along plane V-V in FIG. 4. FIG. 6 is a cross-sectional view of the lower member taken along plane VI-VI in FIG. 4. FIG. 7 is a perspective view of the lower member 10. Incidentally, in the following, a transverse direction in FIG. 4 is sometimes referred to as the transverse direction of the sample rack 1. A longitudinal direction in FIG. 4 is sometimes referred to as the longitudinal direction of the sample rack 1.

As shown in FIGS. 3 to 7, the lower member 10 has the containing-section lower portions 41 that are a recessed portion in which the bottom and side surfaces (the lower portion of the sample holding container 6) of the sample holding container 6 are received. In addition, the containing-section lower portion 41 is a part of the containing section 40. The containing-section lower portion 41 of the present embodiment is formed into approximately cylindrical shape so as to conform to the shape of the sample holding container 6. As the containing-section lower portion 41 is formed to conform to the shape of the sample holding container 6 as described above, it becomes possible for the containing-section lower portion 41 to come into contact with the bottom and side surfaces of the sample holding container 6. Thus, the efficiency of thermal conduction from the containing-section lower portion 41 to the sample holding container 6 is improved. In order to further improve the cooling efficiency of sample liquid through the containing-section lower portion 41, it is preferred to use metal (aluminum, copper, brass or the like) with high thermal conduction efficiency as a material of the lower member 10.

It is preferred that the height of the containing-section lower portion 41 (the depth of the recessed portion) be made to correspond to the height of the liquid level of the sample liquid contained in the liquid holding container 6. This is because cooling only the sample liquid without cooling an unnecessary portion is effective in view of suppressing the formation of dew condensation water as much as possible. In other words, it is preferred that the height of the containing-section lower portion 41 be made equal to or lower than the height of the barrel portion 63a of the sample holding container 63. Preferably, the height of the containing-section lower portion 41 is made approximately equal to the height of the barrel portion 63a at a maximum. If the containing-section lower portion 41 is formed as described above, cooling the vicinity of the septum 62 can be suppressed. Therefore, the formation of dew condensation water on the septum 62 can be suppressed, which can prevent the dew condensation water from entering the inside of the sample holding container along with a needle.

A groove portion 11 is located below the corresponding containing-section lower portions 41, which is a flow passage through which the dew condensation water formed in the sample rack 1 flows. In addition, the groove portion 11 is disposed with inclination with respect to a horizontal plane. The groove portion 11 of the present embodiment extends in the transverse direction of the sample rack 1. In addition, a plurality of the groove portions 11 are rowed in the longitudinal direction of the sample rack 1. The number of rows of the groove portions 11 corresponds to that of the containing sections 40 in the longitudinal direction of the sample rack 1. The groove portions 11 are each formed to decline from the central portion toward both the left and right ends in the transverse direction of the sample rack 1. In addition, the end at which the inclination is steepest is exposed as an opening portion 12 to the outside at both the left and right side surfaces of the lower member 10. The dew condensation water formed in the containing sections 40 passes through the groove portion 11 and then is discharged to the outside of the sample rack 1 via the opening portions 12.

The containing-section lower portion 41 of the present embodiment communicates with another containing-section lower portion 41 adjacent thereto in the transverse direction of the sample rack 1 via a communicating portion 13 installed on the side surface thereof. The communicating portion 13 communicates with the groove portion 11 disposed below the bottom surface of the containing-section lower portion 41. The bottom end of the communicating portion 13 conforms to the bottom surface of the groove portion 11. In other words, the groove portion 11 of the present embodiment communicates with the side surface of the containing-section lower portion 41. The dew condensation water can be discharged also from the side surface of the containing-section lower portion 41 to the groove portion 11. As described above, with such a configuration in which the discharge can be made also from the side surface of the containing-section lower portion 41, the dew condensation water can be permitted to flow down to the groove portion 11 via a portion of the side surface of the sample holding container 6, the portion facing the communicating portion 13. Thus, the dew condensation water can be discharged more forcibly compared with a case where discharge of the dew condensation water is made possible only from the bottom surface of the receiving-portion lower portion 41.

Incidentally, in the present embodiment, a plurality of the groove portions 11 formed with inclination in the transverse direction of the sample rack 1 are arranged in the longitudinal direction of the sample rack 1. However, a plurality of the groove portions 11 formed with inclination in the longitudinal direction of the sample rack 1 may be arranged in the transverse direction of the sample rack 1.

As shown in FIG. 3, the upper member 20 has the containing-section upper portion 42 that forms a hole adapted to receive the side surface of the sample holding container 6 (the upper portion of the sample holding container 6). In addition, the containing-section upper portion 42 is a part of the containing section 40. The containing-section upper portion 42 of the present embodiment is formed into approximately cylindrical shape so as to conform to the shape of the sample holding container 6 similarly to the containing-section lower portion 41.

Incidentally, in view of suppressing the formation of dew condensation water in the vicinity of the septum 62 of the sample holding container 6, it is preferred that the upper member 20 (the containing-section upper portion 42) be formed of a material having relatively lower efficiency of thermal conduction as compared with that of the lower member 10 (the containing-section lower portion 41). (In other words, it is preferred that the lower member 10 (the containing-section lower portion 41) be formed of a material having relatively higher efficiency of thermal conduction as compared with that of the upper member 20 (the containing-section upper portion 42). Specifically, it is preferred that a foam material (polypropylene (PP), polystyrene (PS), etc.), rubber sponge (ethylene-propylene-diene rubber (EPDM), silicone rubber (Si), etc.), or resin (PP, polyphenylene-sulfide (PPS), polyphenylene ether (PPE), denatured polyphenylene ether (m-PPE) etc.) be used for the upper member 20.

The cover member 30 has a hole 43 adapted to receive the sample holding container 6 inserted thereinto, the hole being a part of the containing section 40. Similarly to the containing-section lower portion 41, the hole 43 of the present embodiment is formed into approximately cylindrical shape to conform to the shape of the sample holding container 6. In view of ensuring the strength of the sample rack 1, it is preferred that metal materials (stainless steel, aluminum or the like) or resin (PP, PPE, m-PPE) be used as a material of the cover member 30.

The rack holder 5 is a portion on which the sample rack 1 is placed in the sample introduction device 100. The rack holder 5 removably supports the sample rack 1; therefore, the sample holding container 6 can be loaded into and removed from the sample rack 1 at any place. Since the rack holder 5 is configured as above, attachment and detachment work for the sample holding containers can be done at another place with the sample rack 1 is removed from the rack holder 5. Thus, user's operability can be enhanced. If a plurality of the sample racks 1 are prepared and installation work for the sample holding containers 6 is previously done, sample liquid can be replaced quickly.

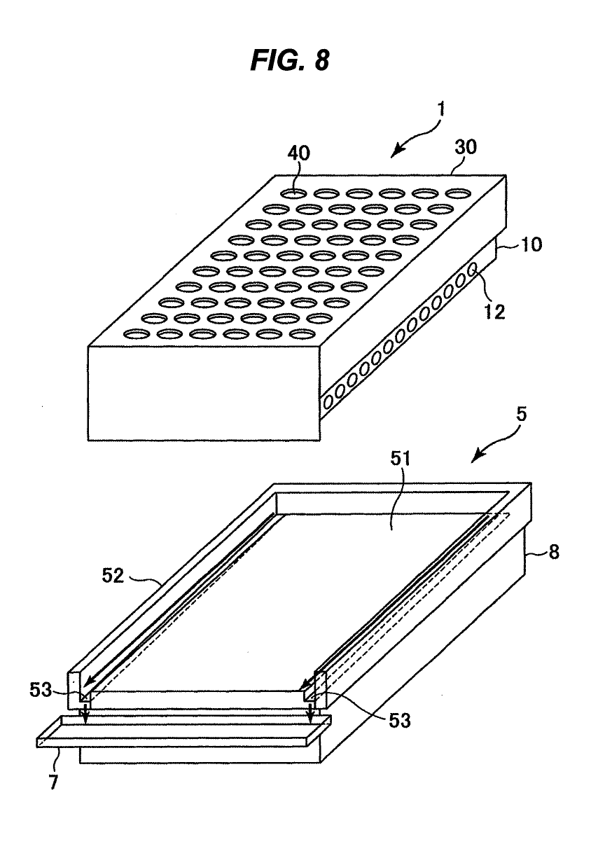

FIG. 8 is a configurational view of the rack holder 5 and the vicinity thereof according to the embodiment of the present invention. As shown in the figure, the rack holder 5 has two groove portions 53 (the other groove portions) disposed with inclination. When the sample rack 1 is placed on the rack holder 5, the groove portion 53 is provided to be located below the opening portion 12. The groove portions 53 of the present embodiment are formed to extend in the longitudinal direction of the sample rack 1 so as to correspond to a plurality of the opening portions 12 arranged on both the left and right side surfaces of the sample rack 1. In addition, the groove portions 53 are formed to decline toward the front side in FIG. 8. A water storage tray 7 (water storing means) for storing water (dew condensation water) discharged from the groove portion 53 is installed below the end (on the front side in FIG. 8) at which the groove portion 53 extends.

Incidentally, although the present embodiment is configured such that the groove portion 53 is disposed in the rack holder 5 and water passed through the groove portion 11 of the sample rack 1 and through the groove portion 53 of the rack holder 5 is stored in the water storage tray 7, another configuration may be adoptable in which other passage is installed to directly introduce, to the water storage tray 7, water discharged from the opening portion 12 of the sample rack 1.

The rack holder 5 of the present embodiment is formed of a plate-like first member 51 and a second member 52 surrounding the first member 51 from the left, right and back sides and provided with the groove portions 53. A cooling device 8 configured by using a Peltier element or the like is installed below the first member 51. The cooling device 8 cools the sample holding container 6 via the rack holder 5 and via the sample rack 1 and keeps the sample liquid in the sample holding container 6 at a predetermined temperature. Therefore, in view of efficiently cooling the sample liquid, it is preferred to ensure a contact area large as much as possible between the first member 51 and the lower member 10 of the sample rack 1. In addition, in view of the same, it is preferred that the first member 51 be formed of metal (aluminum, copper, bronze or the like) with high thermal conduction efficiency similarly to the lower member 10 of the sample rack 1. On the other hand, in view of suppressing the lowering of a cooling effect due to the formation of dew condensation water around the first member 51, it is preferred that the second member 52 be formed of a material with lower efficiency of thermal conduction as compared with that of the first member 51.

In the sample introduction device 100 configured as described above, when the cooling device 8 is actuated to keep the sample liquid in the sample holding container 6 at a fixed temperature (a target temperature), the rack holder 5 is cooled by the cooling device 8. The rack holder 5 thus cooled cools the sample liquid in the sample holding container 6 via the lower member 10 of the sample rack 1. In this case, the lower member 10 of the sample rack 1 is in contact with the bottom surface and side surface of the sample holding container 6 at the containing-section lower portion 41. Accordingly, the contact area in this case is larger than that in a case where only the bottom surface of the sample holding container 6 is cooled. Thus, the sample liquid in the sample holding container 6 is cooled efficiently. In particular, if only the bottom surface of the sample holding container 6 is cooled, upper sample liquid is hard to be cooled. Thus, a temperature difference in the height direction of the sample liquid is likely to occur. In the present embodiment, however, the sample liquid is cooled by heat not only from the bottom surface of the sample holding container 6 but also from the side surface thereof. Therefore, it is possible to suppress the occurrence of the temperature difference in the height direction of the sample liquid.

While the sample liquid is cooled as described above, dew condensation may occur on the sample holding container 6 or the sample rack 1 depending on environmental conditions such as ambient temperature, ambient moisture and the like or setting conditions such as target temperature. However, the sample rack 1 according to the present embodiment has the groove portion 11 disposed below the containing section 40 with inclination and communicating with the bottom surface of the containing section 40. Therefore, dew condensation water formed does not accumulate on the containing section 40 and is forcibly discharged to the outside of the sample rack 1 via the groove portion 11. In other words, if the sample rack 1 is formed as described above, problems can be solved which will arise in lowering of cooling capacity due to the accumulation of dew condensation water and in scattering of dew condensation water on the user and the vicinity of the device when the sample rack 1 is removed. Thus, according to the present embodiment, as dew condensation water is forcibly discharged, it is possible to improve workability encountered during the removal of the sample rack 1 and sample cooling capacity.

Incidentally, the rack holder 5 according to the present embodiment is provided with the groove portion 53 with inclination so as to be located below the opening portion 12. Therefore, the dew condensation water formed at the periphery of the sample holding container 6 passes through the groove portion 11 of the sample rack 1 and is forcibly discharged from the opening portion 12. The dew condensation water thus discharged passes through the groove portion 53 and is recovered by the water storage tray installed in front of the sample introduction device 100. In this way, since also processing of the dew condensation water is facilitated, the workability encountered during removal of the sample rack 1 is further improved.

A second embodiment is next described. In comparison with the previous embodiment, the present embodiment is mainly different therefrom in the shape of a lower member 10A of a sample rack 1A and in the shape of a first member 51A of a rack holder 5A.

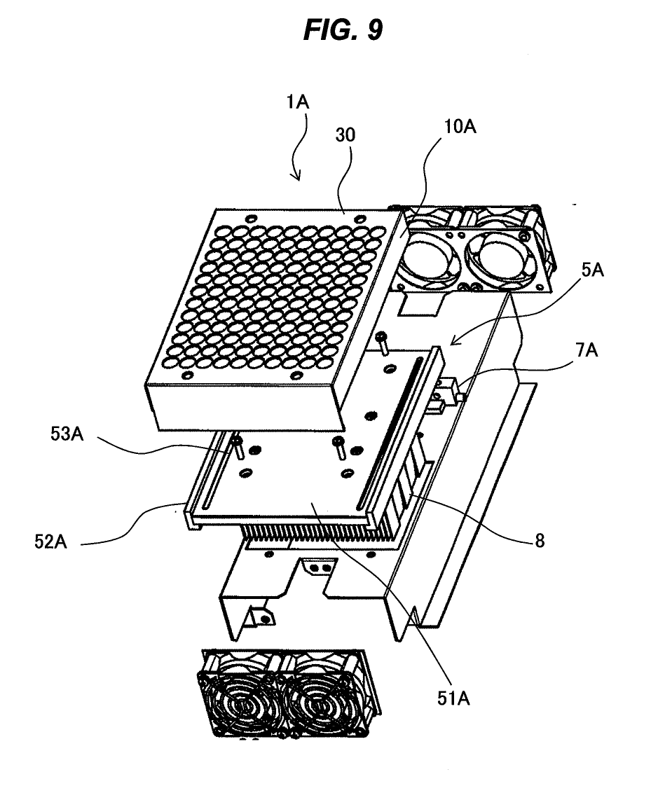

FIG. 9 is an overview illustration showing the configuration of a cooling device of an automatic sample introduction device, according to the second embodiment of the present invention. The sample introduction device shown in the figure mainly includes the sample rack 1A, the rack holder 5A and a water storage tray 7A. The sample rack 1A has a lower member 10A. The rack holder 5A has the first member 51A and a second member 52A.

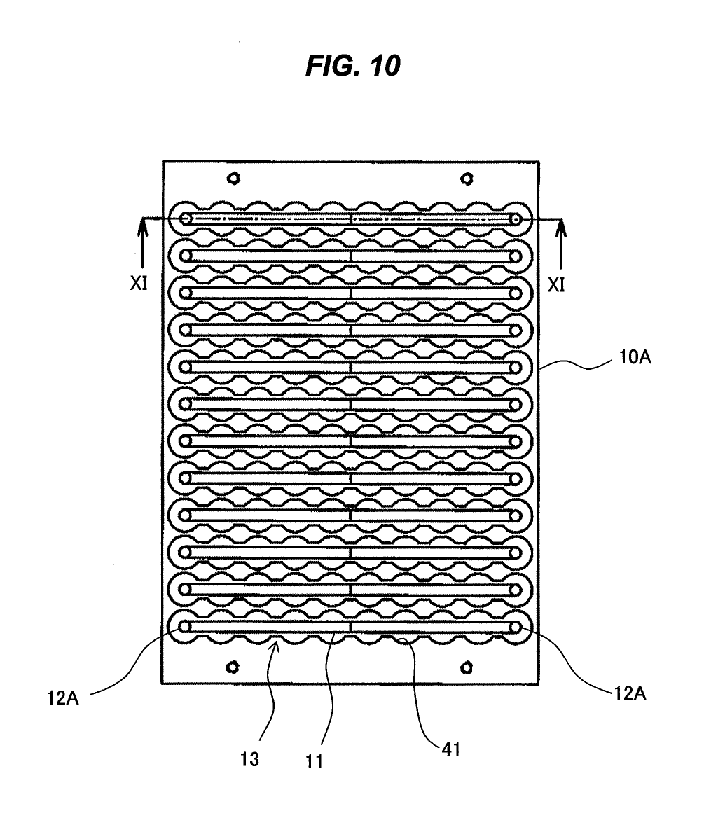

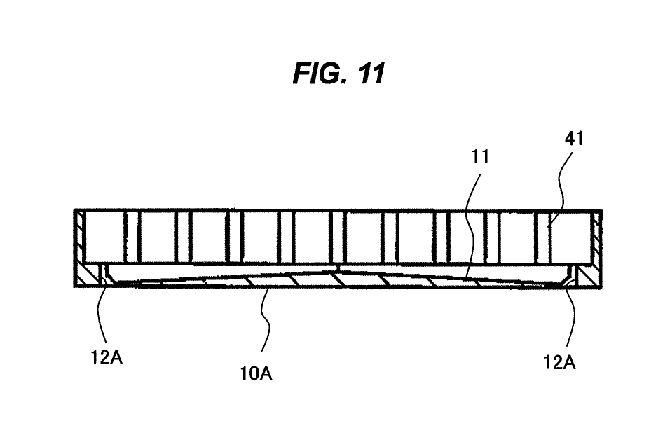

FIG. 10 is a plan view of the lower member 10A of the sample rack 5A according to the present embodiment. FIG. 11 is a cross-sectional view of the lower member 10A taken along plane XI-XI in FIG. 10.

Among the containing-section lower portions 41 of the lower portion 10A shown in the figures, those located at both left and right ends of the sample rack 1A have respective opening portions 12A each opening to the bottom surface of the lower member 10A. The opening portions 12A communicate with a groove portion 11. The dew condensation water formed in the containing section 40 passes through the groove portion 11 and then is discharged to the outside of the sample rack 1A via the opening portions 12A.

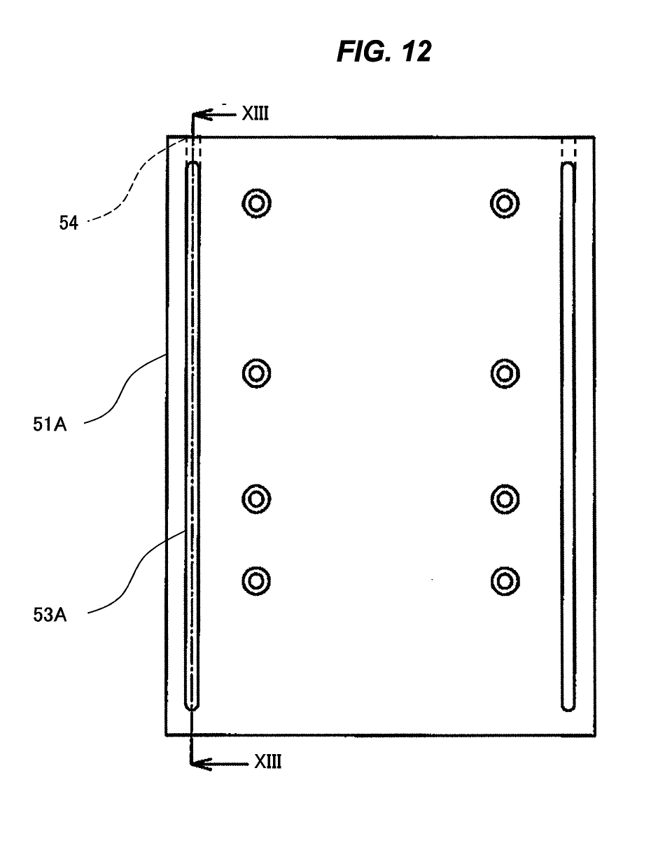

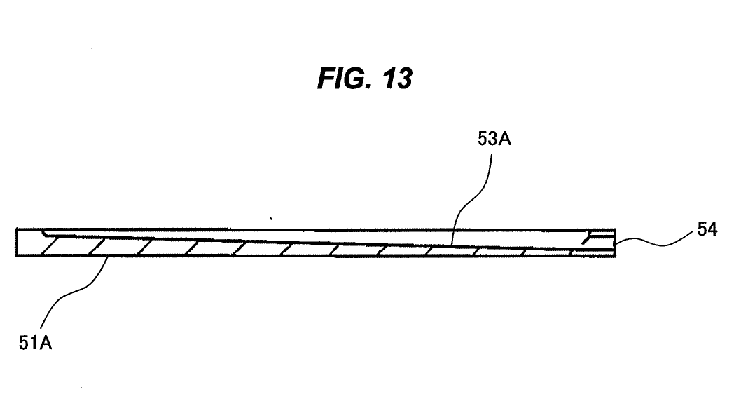

FIG. 12 is a plan view of the first member 51A of the rack holder 5A according to the present embodiment. FIG. 13 is a cross-sectional view taken along plane XIII-XIII in FIG. 12.

The first member 51A shown in the figures has two groove portions 53A each disposed with inclination. The groove portions 53A are each disposed so as to be located below the opening portion 12A of the lower member 10A when the sample rack 1A is placed on the rack holder 5A. In addition, each of the groove portions extends in the longitudinal direction so as to correspond to the position of the associated opening portion 12A. The groove portions 53A of the present embodiment are formed to decline toward the back from the front in FIG. 9 (from the downside to the upside in FIG. 12). In addition, the groove portion 53A communicates at the lowermost end of the decline with an opening portion 54 provided on a side surface of the first member 51A. A water storage tray 7a is installed below the opening portions 54. Incidentally, in view of the same as that of the previous embodiment, the first member 51A be preferably formed of metal with high thermal conduction efficiency. In addition, the second member 52A be preferably formed of a material with low thermal conduction efficiency.

Although the automatic sample introduction device is configured described above, the dew condensation water formed during the cooling of sample liquid can be discharged to the outside via the groove portions 11 and opening portions 12A of the sample rack 1A. Further, the discharged water can be recovered by the water storage tray 7A via the groove portions 53A and opening portions 54 of the rack holder 5A. Thus, also the present embodiment can produce the same effect as that of the previous embodiment.

Incidentally, the above description is given taking as an example the sample introduction device equipped with the cooling device 8. However, needless to say, the present invention can be applied also to a sample cooling device in which a sample introduction function is omitted in the sample introduction device.

### EXPLANATION OF REFERENCE NUMERALS

1 Sample rack

5 Rack holder

6 Sample holding container

7 Water storage tray

8 Cooling device

10 Lower member

11 Groove portion

12 Opening portion

13 Communicating portion

20 Upper member

30 Cover member

40 Containing section

41 Containing-section lower portion

42 Containing-section upper portion

43 Hole

53 Groove portion

54 Opening portion

61 Cap

62 Septum

63a Barrel portion

63b Neck portion

100 Sample introduction device

1. A sample rack in which a sample holding container containing sample liquid is loaded, comprising:
a containing section, the sample holding container being contained in the containing section; and
a groove portion disposed with inclination below the containing section;
wherein a bottom surface of the containing section communicates with the groove portion.

2. The sample rack according to claim 1,
wherein the containing section is configured to be able to come into contact with a bottom surface and a side surface of the sample holding container when the sample holding container is contained in the containing section.

3. The sample rack according to claim 1,
wherein the groove portion is disposed with inclination below the bottom surface of the containing section, communicates with an outside at an end where the inclination is steepest, and further communicates with a side surface of the containing section.

4. The sample rack according to claim 1,
wherein the containing section has, as a part of the containing section, a containing-section lower portion adapted to receive a bottom surface and a side surface of the sample holding container, and as a part of the containing section, a containing-section upper portion located above the containing-section lower portion and adapted to receive the side surface of the sample holding container; and
wherein the containing-section lower portion is formed of a material with relatively higher efficiency of thermal conduction as compared with that of the containing-section upper portion.

5. The sample rack according to claim 4,
wherein a height of the containing-section lower portion is equal to or lower than that of a barrel portion of the sample holding container when the sample container is contained in the containing section.

6. A sample cooling device comprising:
the sample rack of claim 1;
a rack holder for supporting removably the sample rack;
a cooling device adapted to cool the rack holder; and
water storing means for storing water discharged from the groove portion.

7. The sample cooling device of claim 6,
wherein the rack holder is formed of a material with relatively higher efficiency of thermal conduction as compared with that of the containing-section upper portion.

8. The sample cooling device according to claim 6,
wherein the rack holder has a second groove portion disposed with inclination below the groove portion and adopted to receive water discharged from the groove portion, and
wherein the water storing means stores water that has been discharged from the groove portion and passed through the second groove portion.

9. A sample introduction device having the sample cooling device of claim 6.

10. A liquid chromatographic apparatus having the sample introduction device of claim 9.
